(19) United States
(12) Patent Application Publication
(10) Pub. No.: US 2012/0160847 A1
(43) Pub. Date: Jun. 28, 2012

(54) FUEL FILLER PIPE HAVING FORMED TRIGGER POINT

(75) Inventors: Marwan Elbkaily, Canton, MI (US); Balachandra Deshpande, Novi, MI (US)

(73) Assignees: FORD GLOBAL TECHNOLOGIES, LLC, Dearborn, WA (US); FORD MOTOR COMPANY, Dearborn, MI (US)

(21) Appl. No.: 13/411,136

(22) Filed: Mar. 2, 2012

Related U.S. Application Data
(62) Division of application No. 11/558,548, filed on Nov. 10, 2006, now abandoned.

(51) Int. Cl. B60K 15/04

(52) U.S. Cl. 220/86.2

(57) ABSTRACT

A fuel filler pipe includes a trigger point formed between the fuel supply port and the fuel tank. The trigger point is a trough-like depression which, if there is a structural disruption of the vehicle, will facilitate a buckling mode in the pipe and consequent energy absorption.

### CROSS-REFERENCE TO RELATED APPLICATIONS

This application is a divisional application of U.S. Ser. No. 11/558548, filed on Nov. 10, 2006. U.S. Ser. No. 11/558,548 is incorporated by reference herein.

### TECHNICAL FIELD

The present invention relates generally to vehicle fuel systems. More specifically, the present invention relates to a fuel pipe having a trigger point which allows the fuel pipe to buckle if there is a structural disruption of the vehicle, thus reducing or entirely eliminating the amount of displacement of the fuel filler pipe into the fuel tank during the structural disruption.

### BACKGROUND OF THE INVENTION

In the modern motor vehicle fuel is delivered to the fuel tank by a fuel filler pipe. The fuel filler pipe creates a fluid connection between the fuel supply port disposed within the fuel filler housing and the fuel tank. Fuel filler pipes are made of a metal or a synthetic resin. Those fuel filler pipes composed of metal are typically composed of stainless steel, aluminum, or steel.

Fuel systems in motor vehicles, including the fuel filler pipe, must meet certain safety standards. In seeking to surpass known standards, motor vehicle manufacturers attempt to improve the integrity of their vehicle fuel system designs. One sought-after improvement has to do with the fuel filler pipe of the fuel system and how it reacts in the event of a structural disruption of the vehicle. Accordingly, as in so many areas of motor vehicle technology, there is room in the art of motor vehicle fuel systems for providing an alternative configuration to known fuel filler pipe designs.

### SUMMARY OF THE INVENTION

The present invention provides an alternative configuration for a fuel filler pipe which includes an area of reduced cross-section relative to the rest of the fuel filler pipe which defines a crumple area or a trigger point in the fuel filler pipe. The trigger point formed in an appropriate location facilitates a buckling mode in the pipe in the event that there is a structural disruption of the vehicle and consequent energy absorption. By providing the trigger point in an appropriate place in the fuel filler pipe, during such a disruption the amount of possible displacement or intrusion of the pipe into the fuel tank is reduced or eliminated.

With the trigger point provided at an appropriate location on the fuel filler pipe with an appropriate geometry, an alternative construction of the current fuel filler pipe is provided.

Other advantages and features of the invention will become apparent when viewed in light of the detailed description of the preferred embodiment when taken in conjunction with the attached drawings and the appended claims.

### BRIEF DESCRIPTION OF THE DRAWINGS

For a more complete understanding of this invention, reference should now be made to the embodiment illustrated in greater detail in the accompanying drawings and described below by way of examples of the invention wherein:

FIG. 1 shows an elevation view of a fuel filler pipe in relation to a fuel tank, partially broken away, according to the prior art;

FIG. 2 shows an elevation view of a fuel filler pipe in relation to a fuel tank, partially broken away, according to the present invention;

FIG. 3 shows a close-up view of the trigger point of the fuel pipe of the present invention;

FIG. 3a shows a perspective view of the fuel pipe depicted in FIG. 3 in which a side portion is cutaway to illustrate a part of the trigger point;

FIG. 4 is a cross section of the trigger point of the fuel filler pipe according to the present invention taken along lines 4-4 of FIG. 3; and

FIG. 5 shows the fuel filler pipe and fuel tank of FIG. 2 after a structural disruption of the vehicle with the filler pipe in a buckled condition.

### DETAILED DESCRIPTION OF THE PREFERRED EMBODIMENT

In the following figures, the same reference numerals will be used to refer to the same components. In the following description, various operating parameters and components are described for one constructed embodiment. These specific parameters and components are included as examples and are not meant to be limiting.

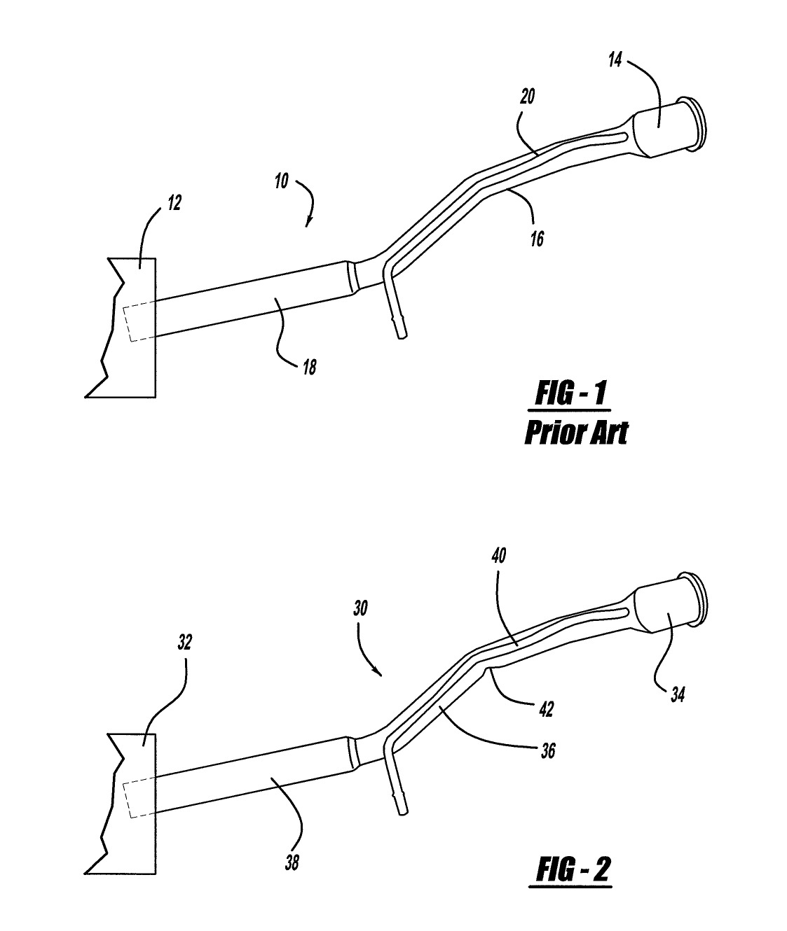

With reference to FIG. 1, a fuel delivery assembly according to known technology, generally illustrated as 10. The fuel delivery assembly 10 includes a fuel tank 12, a fuel filler port 14, and a fuel filler pipe 16 connected to a fuel tank inlet pipe 18. An air vent tube 20 is provided in fluid relation to the fuel filler port 14. As is known in the art, the fuel filler pipe 16 is of a constant diameter between the fuel filler port 14 and the fuel tank pipe 18.

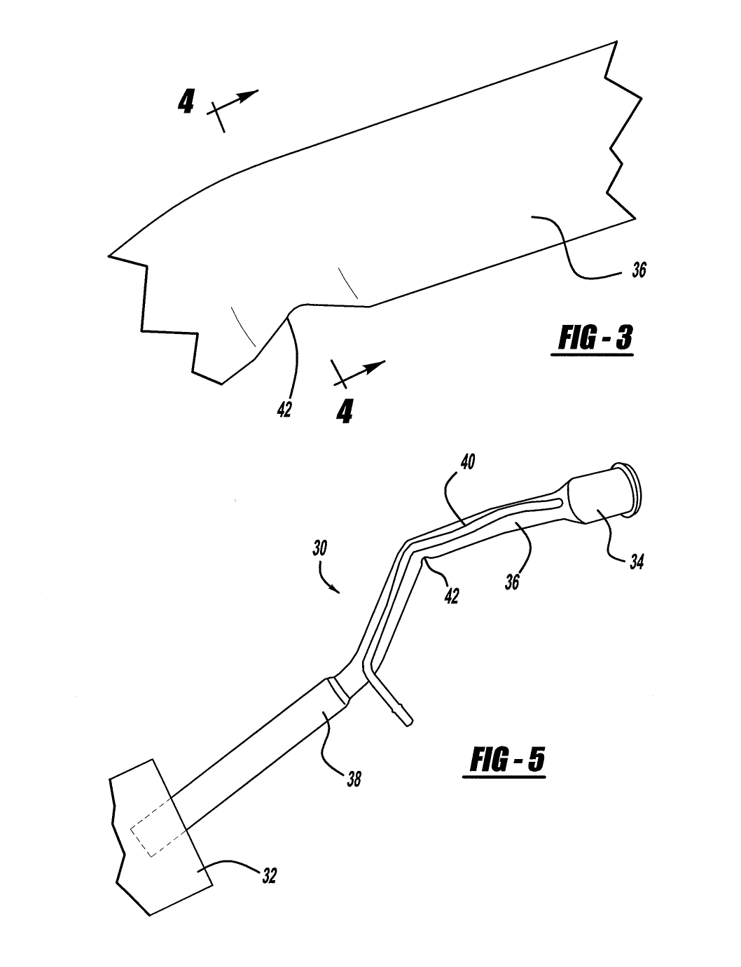

With reference to FIGS. 2 through 4, a fuel delivery assembly according to the present invention, generally illustrated as 30, is shown. The fuel delivery assembly 30 includes a fuel tank 32, a fuel filler port 34, and a fuel filler pipe 36 connected to a fuel tank inlet pipe 38. In addition, an air vent tube 40 is provided in fluid relation to the fuel filler port 34 as is conventionally provided.

The diameter of the fuel filler pipe 36 from its inlet end at the fuel filler port 34 to its outlet end at the fuel tank inlet pipe 38 is relatively constant with the exception of an area of reduced cross-section which defines a crumple area or a trigger point 42 which is located on a bend of the fuel filler pipe 36. The trigger point 42 defines a trough-like depression and may be formed by any one of several known methods, including formation by a punch or by stamping. The thickness of the wall of the fuel filler pipe 36 at the trigger point 42 may be the same as the thickness of the other areas of the wall of the fuel filler pipe 36 or may be of reduced thickness to allow for more effective buckling if there is a structural disruption of the vehicle.

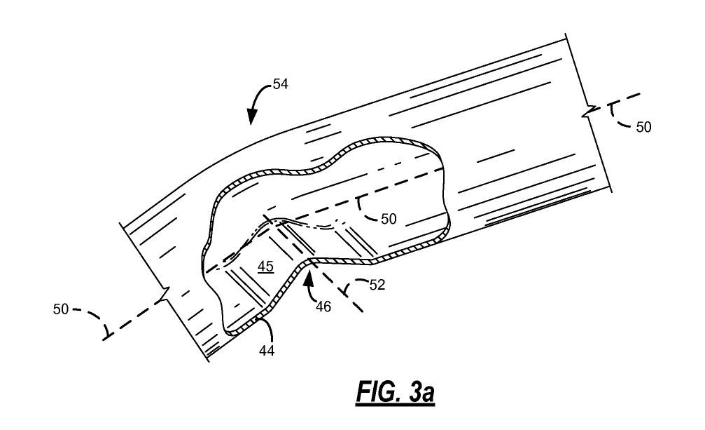

A close-up view of the trigger point is depicted in FIG. 3a, which shows a portion of the pipe wall 44 cut away to illustrate an interior space of the pipe and a wall surface 45. Also depicted is a ghost line 50, which represents a long axis of the pipe and pipe body. A ridge portion 46 is formed where the wall 44 is depressed into the interior space. The ridge portion 46 extends in a substantially straight orientation traverse to the long axis. The substantially straight orientation of the ridge portion 46 is illustrated by ghost line 52, which is traverse to ghost line 50. The trigger point 42 is preferably formed at the bend 54 of the fuel filler pipe 36 as illustrated to increase the tendency of this area to form a hinge upon loading.

Correct placement and geometry of the trigger point 42 relative to the fuel filler pipe 36 are factors that need to be carefully considered. As illustrated particularly in FIG. 2, the trigger point 42 is disposed at the bent area of the fuel filler pipe 36 that is formed roughly half-way between the fuel filler port 34 and the fuel tank inlet pipe 38. According to such placement, if there is a structural disruption of the vehicle the trigger point 42 facilitates a buckling mode and consequently absorbs energy that would otherwise cause displacement or intrusion of the fuel tank inlet pipe 38 into the fuel tank 32.

While the trigger point 42 is illustrated as being at the approximate mid-point of the fuel filler pipe 36 between the fuel filler port 34 and the fuel tank inlet pipe 38, the trigger point 42 may be formed at an alternative point on the fuel filler pipe 36 or there may be two or more trigger points fitted on the fuel filler pipe 36.

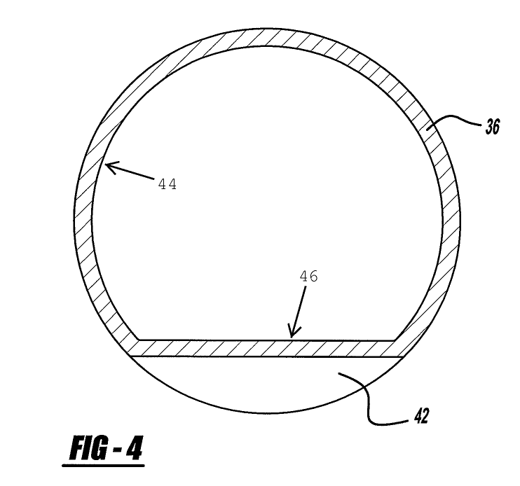

A cross-sectional view of the fuel filler pipe 36 at the trigger point 42 is illustrated in FIG. 4. A certain percentage of the circumference of the filler pipe 36 is encompassed by the trigger point 42. The trigger point 42 includes an interior wall 44 and a straight bridge portion 46. As illustrated, about 20 percent of the circumference of the filler pipe 36 is encompassed by the trigger point 42. However, it is to be understood that a greater or lesser percentage of the circumference of the filler pipe 36 may be encompassed by the trigger point 42 without deviating from the scope of the present invention. Preferably the trigger point 42 will encompass between about 10 and 30 percent of the circumference of the filler pipe 36. In any event, it is preferable that the trigger point 42 not be axisymmetric to avoid the backflow of fuel which might otherwise result.

The possible result of a structural disruption of the vehicle is illustrated in FIG. 5 where the impact force has been transmitted to the trigger point 42 which has absorbed the energy from the impact force that caused the structural disruption of the vehicle and has allowed a slight angular deformation or buckling of the fuel filler pipe 36 at the trigger point 42. Intrusion of the fuel tank inlet pipe 38 has thus been avoided and, in addition, no rupturing of the connection between the fuel tank inlet pipe 38 and the fuel tank 32 has occurred, virtually eliminating the possibility of fuel spillage.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A fuel filler pipe that fits between a fuel tank and a fuel-supply port of a motor vehicle, the fuel filler pipe comprising:
a fuel-filler-pipe body having a long axis,
a fuel-tank end at one end of the fuel-filler pipe, and
a fuel-supply-port end at another end of the fuel filler pipe, said fuel-filler-pipe body having a bend formed between said fuel-tank end and said fuel-supply-port end, said fuel-filler-pipe body further including a trigger point formed at said bend, the trigger point comprising a wall of the fuel-filler-pipe body depressed into an interior space of the fuel-filler-pipe body, wherein a ridge portion is formed by the wall, the ridge portion extending substantially straight in an orientation transverse to the long axis of the fuel-filler-pipe body.

2. The fuel-filler pipe of claim 1, wherein said fuel-filler-pipe body has a cross section and said trigger point has a cross section, said cross section of said trigger point being smaller than said cross section of said fuel-filler-pipe body.

3. The fuel-filler pipe of claim 2, wherein the cross section of the trigger point is between about 10 percent and about 30 percent smaller than the cross section of the fuel-filler-pipe body.

4. The fuel-filler pipe of claim 3, wherein the cross section of the trigger point is about 20 percent smaller than the cross section of the fuel-filler-pipe body.

5. The fuel filler pipe of claim 1, wherein said trigger point is defined by a bend formed in said fuel-filler-pipe body.

6. A fuel delivery assembly for a motor vehicle, the fuel delivery assembly comprising:
a fuel filler supply port;
a fuel filler pipe connected to said fuel filler supply port, said fuel filler pipe having a body with a trigger point comprising a crimp formed in the body, said crimp having an interior wall within said body that defines a straight bridge portion extending transverse to a long axis of said body; and
a fuel tank inlet pipe connected to said fuel filler pipe and connected to a fuel tank, said body of the fuel filler pipe extending between the fuel tank inlet pipe and the fuel filler supply port.

7. The fuel delivery assembly of claim 6, wherein said body has a cross section and said trigger point has a cross section, said cross section of said trigger point being smaller than said cross section of said body.

8. The fuel delivery assembly of claim 7, wherein the cross section of the trigger point is between about 10 percent and about 30 percent smaller than the cross section of the body.

9. The fuel delivery assembly of claim 8, wherein the cross section of the trigger point is about 20 percent smaller than the cross section of the body.

10. The fuel delivery assembly of claim 6, wherein said trigger point is positioned at a bend formed in said body.

11. A fuel filler pipe that fits between a fuel tank and a fuel supply port of a motor vehicle, the fuel filler pipe comprising:
a fuel-filler-pipe body having a cross-sectional area and a long axis;
a fuel-tank end on one end of the fuel filler pipe; and
a fuel-supply-port end on another end of the fuel filler pipe, said fuel-filler-pipe body including a trigger point comprising a wall of the fuel-filler-pipe body depressed into an interior space of the fuel-filler-pipe body,
wherein the cross-sectional area at the trigger point is reduced by between about 10 and 30 percent, and
wherein a ridge portion is formed by the wall, the ridge portion extending substantially straight in an orientation transverse to the long axis of the body.

12. The fuel filler pipe of claim 11, wherein said trigger point is positioned at a bend formed in said fuel-filler-pipe body.

13. The fuel filler pipe of claim 11, wherein the cross section of the trigger point is about 20 percent smaller than the cross section of the body.
